(19) United States
(12) Patent Application Publication
(10) Pub. No.: US 2001/0037392 A1
(43) Pub. Date: Nov. 1, 2001

(54) Information display apparatus and display method of the same

(75) Inventor: Doo Sang Park, Seoul (KR)

Correspondence Address: JONATHAN Y. KANG, ESQ., LEE & HONG P.C., 11th Floor, 221 N. Figueroa Street, Los Angeles, CA, 90012-2601, US

(73) Assignee: LG Electronics Inc.

(21) Appl. No.: 09/844,821

(22) Filed: Apr. 27, 2001

(30) Foreign Application Priority Data
Apr. 28, 2000 (KR) 22809/2000

(51) Int. Cl. G06F 15/16; G06F 15/173

(52) U.S. Cl. 709/227; 709/237

(57) ABSTRACT

In an information display apparatus and a display method of the same displaying information transmitted from a network on a PC phone and a communication terminal using Internet protocol, information transmitted through a network is stored, is transmitted to an Internet phone when the Internet phone assumes an on-hook status, and is displayed on a display unit of the Internet phone. An information server of the information display apparatus broadcasts certain message information to Internet phones or PC phones, which each stores information transmitted from the network in its memory in order to display the information such as various advertisements, guides, bulletins, etc. on a display unit thereof. When the Internet phone assumes an on-hook status, the information stored in the memory of the information server is transmitted to the Internet phone, and is displayed on the display unit of the Internet phone.

### BACKGROUND OF THE INVENTION

1. Field of the Invention

The present invention relates to a multimedia system, and in particular to an information display apparatus and a display method of the same for displaying information transmitted from a communication network on a PC phone and a communication terminal using an Internet protocol.

2. Description of the Prior Art

FIG. 1 is a schematic block diagram illustrating a general VoIP (Voice Over Internet Phone) system. As depicted in FIG. 1, the VoIP system includes a gateway system 110 for converting communication protocols between a PSTN (Public Switched Telephone Network) and the Internet and connecting to the PSTN and Internet, an information server 120 providing additional functions such as a VMS (Voice Mail System) by connecting to the gateway system 110, PC (Personal Computer) phones 130, 140, and communication terminals 150, 160 using Internet protocols through a local network, and the PC phones 130, 140 or communication terminals 150, 160 (hereafter, the communication terminal is referred to as an Internet phone) using Internet protocols for performing voice communication or data communication with other PC phones (not shown) or Internet phones (not shown) connected to the PSTN and Internet through the information server 120.

A memory unit of the PC phones 130, 140 and Internet phones 150, 160 stores information such as an extension number, an IP address, a number of ones group, etc.

An operation of the information display apparatus in accordance with the prior art will now be described.

In order to provide voice communication for a user, when the user presses a certain button of the PC phone 130 or Internet phone 150 and inputs a telephone number or an IP address of a terminal of an other party connected to the PSTN or Internet, the gateway system 110 performs a call connection by analyzing the inputted IP address or telephone number and transmitting a call setup signal to the i0 terminal of the other party through the PSTN or Internet. When the call is set between the gateway system 110 and terminal of the other party, the gateway system 110 transmits voice data packets from the PC phone 130 or Internet phone 150 to the terminal of the other party or transmits an analog signal after converting the voice data packets into the analog signal.

On the contrary, when the gateway system 110 receives a call setup signal for voice communication from the Internet or PSTN, the gateway system 110 checks whether or not voice communication is possible by transmitting the call setup signal to the PC phone 130 or Internet phone 150 which corresponds to the call setup signal, and when the voice communication is possible, message data packets and a voice packet transmitted from the Internet or PSTN are transmitted to the called PC phone 130 or Internet phone 150. Accordingly, the user can have the voice communication with the other party through the Internet or PSTN.

Next, in voice communication between the PC phones 130, 140 and/or Internet phones 150, 160 in a local network, it is possible to provide voice communication for the users with the PC phones 130, 140 and/or Internet phones 150, 160 locally without passing through the gateway system 110.

The information server 120 judges an on-hook or off-hook status of a pertinent terminal by checking for a status change of the PC phones 130, 140 or Internet phones 150, 160. Because on-hook or off-hook information transmitted from the PC phones 130, 140 or Internet phones 150, 160 includes an IP address, there is no need to store the IP address in a memory unit 223 of the information server 120.

Although various products differ a little, a display window of the Internet phone generally displays the present time, the date and its station ID in an on-hook status.

As described above, the display unit of the PC phones 130, 140 or Internet phones 150, 160 in accordance with the prior art can simply display the present time, the date or the telephone number of the other party, but can not display some more information provided from the PSTN or Internet.

### SUMMARY OF THE INVENTION

An object of the present invention is to provide an information display apparatus and a display method of the same which is capable of displaying information on a display unit of terminals connected to a local network by storing various information received from an external or a local network and transmitting the stored information to the terminals in an on-hook status.

Another object of the present invention is to provide an information display apparatus and a display method of the same which is capable of broadcasting certain message information such as various advertisements, guides, bulletins from an information server of a VoIP system to each Internet phone or PC phone, and displaying the certain message on a display unit of an Internet phone.

In order to achieve the objects of the present invention, there is provided an information display apparatus in accordance with an embodiment of the present invention which comprises a gateway system for converting protocols of an external network and a local network for information exchange between the external network and local network, a plurality of terminals connected to the local network, and an information server for storing various information transmitted from the external network or local network, transmitting the information to each terminal during an on-hook status thereof after checking the on-hook status of the terminal, and displaying the information on a display unit of the terminal.

In addition, in order to achieve the objects of the present invention, an information display apparatus in accordance with another embodiment of the present invention comprises a plurality of terminals connected to a local network, and an information system for converting protocols of an external network and the local network for information exchange between the external and local networks, storing various information transmitted from the external network or local network, checking a call status of the plurality of terminals, transmitting the stored information to each terminal during an on-hook status thereof, and displaying the information on a display unit of the terminal.

In addition, in order to achieve the objects of the present invention, an information display method in accordance with the present invention comprises storing information such as various advertisements, guides, bulletins, etc. transmitted from an external network or a local network, transmitting the stored information to a plurality of terminals connected to the local network during an on-hook status of such terminals after judging a call status of the plurality of terminals connected to the local network, and controlling the plurality of terminals so as to display the received information.

### BRIEF DESCRIPTION OF THE DRAWINGS

FIG. 1 is a schematic block diagram illustrating a general VoIP system.

FIG. 2 is a block diagram illustrating a VoIP system in accordance with the present invention.

FIG. 3 is a flow chart illustrating an operation method of an information display apparatus in accordance with the present invention.

### DETAILED DESCRIPTION OF THE PREFERRED EMBODIMENT

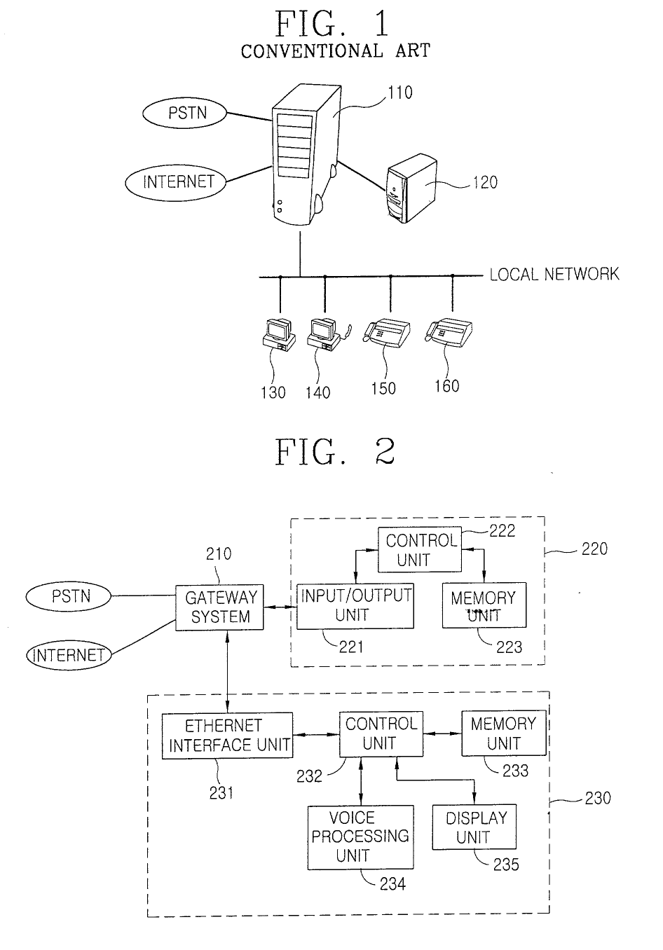

FIG. 2 is a block diagram illustrating a VoIP system in accordance with the present invention. As depicted in FIG. 2, the VoIP system in accordance with the present invention includes a gateway system 210 converting communication protocols between a PSTN and the Internet by interfacing with the PSTN and Internet, an information server 220 providing additional functions such as a VMS (Voice Mail System) by contacting to the gateway system 210 and an Internet phone 230 through a local network, and the Internet phone 230 performing voice communication or data communication with other PC phones (not shown) connected to the PSTN and Internet through the gateway system 210 and information server 220.

The information server 220 includes a memory unit 223 storing information such as an advertisement, a guide, a bulletin, etc., a control unit 222 outputting a control signal for transmitting the information stored in the memory unit 223 of the information server to the Internet phone 230 when a call status of the Internet phone 230 is an on-hook status after judging a call status of the Internet phone 230, and an input/output unit 221 transmitting an on-hook signal of the Internet phone 230 to the information server 220 and transmitting the information stored in the memory unit 223 to the Internet phone according to the control of the control unit 222.

The Internet phone 230 includes an ethernet interface unit 231 inputting/outputting information by connecting to the gateway system 210 and information server 220, a voice processing unit 234 processing received/transmitted voice signals when a call is set up with a terminal of another party, a memory unit 233 storing information transmitted from the information server 220, a display unit 235 such as an LCD displaying contents of the memory unit 233, and a control unit 232 controlling the storing of information received through the ethernet interface unit 231 in the memory unit 233 and the displaying of the information stored in the memory unit 233 on the display unit 235 when a call status of the Internet phone itself is an on-hook status after checking a call status message transmitted to the gateway system 210 and information server 220.

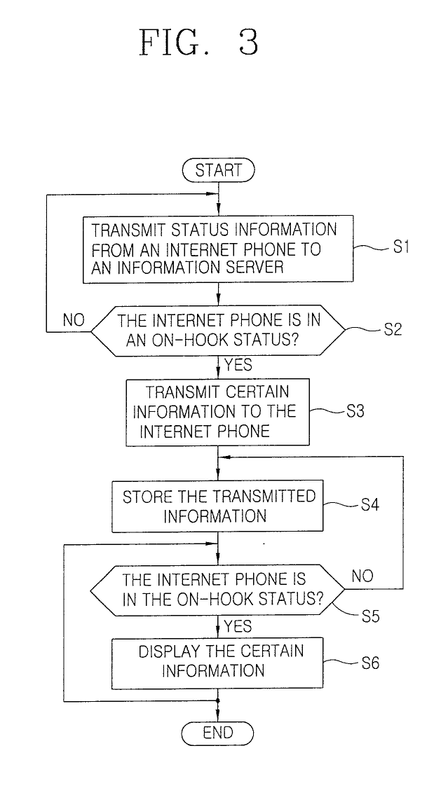

FIG. 3 is a flow chart illustrating an operation method of the information display apparatus in accordance with the present invention.

The information display apparatus and display method of the same in accordance with the present invention will now be described with reference to accompanying FIGS. 2 and 3.

The information server 220 receives information such as an advertisement, a guide, a bulletin, etc. transmitted from the Internet or PSTN, and stores the information in the memory unit 223. In more detail, when the certain information such as the advertisement, guide, bulletin, etc. is received through the input/output unit 221, the control unit 222 reads the received information, and stores it in the memory unit 223 as shown at S1.

The control unit 222 of the information server judges a call status of the Internet phone 230 by using data exchanged between the gateway system 210 and Internet phone 230 in a prior call setup operation. In other words, when the control unit 232 of the Internet phone transmits the call status information included in a call setup message between the Internet phone and gateway system 210 to the information server 220 through the ethernet interface unit 231, the control unit 222 of the information server judges the call status of the Internet phone 230 as shown at S2. Herein, when the control unit 222 judges the call status of the Internet phone 230 as an on-hook status, the control unit 222 of the information server controls the input/output unit 221 so as to transmit the certain information stored in the memory unit 223 to the memory unit 233 of the Internet phone.

In addition, the control unit 232 of the Internet phone controls the input/output unit 221 in order to transmit the certain information such as the advertisement, guide, bulletin, etc. received through the ethernet interface unit 231 to the memory unit 233 of the Internet phone as shown at S3. After that, when the call status of the Internet phone 230 is in the on-hook status, the control unit 232 of the Internet phone temporarily stores the certain information received through the ethernet interface unit 231 in the memory unit 233 as shown at S4, and the control unit 232 of the Internet phone judges continually its call status as shown at S5. Accordingly, in the on-hook status of the Internet phone, the certain information such as the advertisement, guide, bulletin, etc. stored in the memory unit 233 is transmitted to the display unit 235, and the certain information is displayed on the display unit 235 as shown at S6.

After that, if the control unit 232 of the Internet phone judges the call status of the Internet phone 230 as an off-hook status while displaying the certain information on the display unit 235, the control unit 232 ceases the display of the certain information displayed on the display unit 235 and displays voice communication-related information, namely, basic information such as the telephone number of the other party, the date, the time etc. on the display unit 235. In addition, when the control unit 232 of the Internet phone judges the call status of the Internet phone 230 as the on-hook status again, the control unit 232 again displays the certain information stored in the memory unit 233 on the display unit 235.

That is, when the certain information is received from the information server 220 while the Internet phone maintains the off-hook status, the control unit 232 of the Internet phone controls so as to store the received information in the memory unit 223 and waits until the call status is converted into the on-hook status.

In the above-mentioned embodiment, the process for displaying certain information on the display unit 235 by receiving the certain information at only the one Internet phone 230 is described. However, because a plurality of Internet phones can be connected to the gateway system 210, the control unit 222 of the information server has to judge the status of each of the plurality of Internet phones 230. Herein, when a certain number of Internet phones of the plurality of Internet phones 230 are in an on-hook status, the information server 220 transmits the certain information stored in the memory unit 223 to the certain number of Internet phones 230 by a broadcasting method. And, each Internet phone 230 then in an on-hook status stores the certain information transmitted from the information server 220 in its memory unit 233, and judges again its call status. If in the on-hook status, then the control unit 232 of the Internet phone continually displays on its display unit 235 the certain information which was transmitted from the information server 220 during the on-hook status of the plurality of Internet phones 230. When the call status of each of the plurality of Internet phones 230 are converted into an off-hook status, the control unit 232 of each Internet phone waits until the call status is converted into the on-hook status before displaying the received and stored information.

In the above-mentioned embodiment, when the plurality of Internet phones are in the on-hook status, the process for transmitting the certain information from the information server 220 to the plurality of Internet phones 230 has been described, but it is also possible to transmit the certain information only to a certain Internet phone 230 which is in the on-hook status. In more detail, it is possible to transmit the information stored in the memory unit 223 of the information server only to a pre-selected Internet phone 230.

In addition, in another embodiment of the present invention, the memory unit 223 and control unit 222 of the information server 220 can be included in the gateway system 210. In other words, an information system 210, 220 combining the memory unit 223 and control unit 222 with the gateway system 210 can be embodied in order to perform operation of the information server and gateway system altogether by the same method.

In still another embodiment of the present invention, in case of the local network, it is possible to construct the present invention by using only the information server 220 without the gateway system 210. In more detail, in case of voice communication between station users on a local network, when a user presses a certain button on their Internet phone 230 and inputs an IP (Internet Protocol) address or station ID of a PC phone or another Internet phone connected to the local network, a communication to a pertinent terminal having the inputted IP address or station ID is directly connected through the local network. Herein, message packets and voice packets, etc. are transmitted to the terminal of the other party (i.e., a terminal 240 (not shown) connected in same the way as the Internet phone 230) without passing through the gateway system 210. Accordingly, the user can have the voice communication with the other party on the local network.

Meanwhile, the certain information to be displayed such as an advertisement, a guide, a bulletin, etc. can be updated in accordance with a need of a manager of an ISP (Internet Service Provider) or of the local network.

As described above, the present invention can improve the usefulness of an Internet phone by providing services such as various advertisements, guide announcements, etc. to the user using the Internet phone.

What is claimed is:

1. An information display apparatus, comprising:
a gateway system for converting protocols of an external network and a local network for information exchange between the external network and local network;
a plurality of terminals connected to the local network; and
an information server for storing various information transmitted from the external network or local network, transmitting the information to each terminal in an on-hook status thereof after checking the on-hook status of the terminal, and displaying the information on a display unit of the terminal.

2. The apparatus of claim 1, wherein the plurality of terminals are PC phones and Internet phones using Internet protocols for data communication.

3. The apparatus of claim 1, wherein each terminal includes a memory means for storing information transmitted from the information server, and a control means for controlling the storing of the transmitted information in the memory means of the terminal.

4. The apparatus of claim 3, wherein the control means of the terminal judges a call status of the terminal itself.

5. The apparatus of claim 4, wherein the possible call status of the terminal is one of an on-hook status or an off-hook status.

6. The apparatus of claim 3, wherein the terminal includes a display means for displaying information stored in the memory means of the terminal.

7. The apparatus of claim 1, wherein the information server includes a memory means for storing various information transmitted from the external network, and a control means for judging the respective call status of each of the plurality of terminals.

8. The apparatus of claim 7, wherein the control means of the information server transmits the information stored in the memory means thereof to each terminal in an on-hook status.

9. The apparatus of claim 7, wherein the control means of the information server updates contents of the memory means of the information server when new information is received thereby.

10. An information display apparatus, comprising:
a plurality of terminals connected to a local network; and
an information system for converting protocols of an external network and the local network for information exchange between the external and local networks, storing various information transmitted from the external network or local network, checking a call status of each of the plurality of terminals, transmitting the stored information to each terminal during an on-hook status thereof, and displaying the information on a display unit of the terminal.

11. The apparatus of claim 10, wherein the plurality of terminals are PC phones and Internet phones using Internet protocols.

12. The apparatus of claim 10, wherein each terminal includes a memory means for storing information transmitted from the information system, and a control means for controlling the storing of the transmitted information in the memory means of the terminal.

13. The apparatus of claim 12, wherein the control means of the terminal judges a call status of the terminal itself.

14. The apparatus of claim 13, wherein the call status of the terminal is one of an on-hook status or an off-hook status.

15. The apparatus of claim 10, wherein the terminal includes a display means for displaying information stored in a memory means of the terminal.

16. The apparatus of claim 10, wherein the information system includes a memory means for storing various information transmitted from the external network and a control means for judging a call status of each of the plurality of terminals.

17. The apparatus of claim 16, wherein the control means transmits information stored in the memory means thereof to each terminal during an on-hook status thereof.

18. The apparatus of claim 16, wherein the control means of the information system updates contents of the memory means of the information system when new information is received.

19. An information display method, comprising:
storing information such as various advertisements, guides, bulletins, etc. transmitted from an external network or a local network;
transmitting the stored information to a plurality of terminals during an on-hook status thereof after judging a call status of the plurality of terminals connected to the local network; and
controlling the plurality of terminals so as to display the received information.

20. The method of claim 19, wherein in the transmitting step the stored information is transmitted to the plurality of terminals based on judging a call status of only a pre-selected one of the plurality of terminals.

21. The method of claim 19, wherein the controlling step comprises the sub-steps of:
storing the received information at each terminal;
judging the call status of each terminal storing the information; and
displaying the stored information on each terminal during an on-hook status thereof.

22. The method of claim 21, wherein the judging step further comprises:
ceasing the display of the stored information on the terminal when the terminal assumes an off-hook status, and again displaying the stored information when the terminal next assumes an on-hook status.
